(19) United States
(12) Patent Application Publication
(10) Pub. No.: US 2005/0097144 A1
(43) Pub. Date: May 5, 2005

(54) Performance tuning at CM loader program while replicating EQP list for IBM SiView

(75) Inventor: Andrew C.P. Liu, Taipei City (TW)

Correspondence Address: GEORGE O. SAILE, 28 DAVIS AVENUE, POUGHKEEPSIE, NY, 12603, US

(73) Assignee: Taiwan Semiconductor Manufacturing Co.

(21) Appl. No.: 10/700,851

(22) Filed: Nov. 4, 2003

(51) Int. Cl. G06F 7/00

(52) U.S. Cl. 707/200

(57) ABSTRACT

A method and system for improving performance at a central monitor loader program when replicating data between relational databases. Benefits include improved generating speed, near real-time synchronization between source and target databases, and independence from source data volume. The concept of Delete Changed First effectively deletes outdated data records by obtaining a list of changed records using time and date stamp analysis and inserting updated records into target data. Database problem determination and maintenance are made easier as a result of this new method.

### BACKGROUND OF THE INVENTION

1. Field of Invention

This invention relates generally to the relational database management system (RDBMS) data replication, and more particularly, to data replication between relational databases used in a semiconductor manufacturing channel monitoring environment where performance has a high impact on productivity.

2. Description of Related Art

There are many kinds of methods to replicate data from RDBMS to RDBMS, including triggers, stored procedure, and DB logs. No matter which method is used, the outcome is the same whether it be a simple IBM DB2 to DB2 homogeneous replication or a more complex replication between heterogeneous database types. For a more involved requirement such as a data pre-summary that is used to reduce the amount of data that must be accessed, a loader program is useful as its programming language affords more power for computing and doing data conversion.

In the semiconductor manufacturing Fab environment a loader program is usually run from a Central Monitor (CM) program that provides a Graphical User Interface (GUI) which gives a “bird's eye view” of the manufacturing Fab real-time status. There are usually two major steps within a loader program. Step one involves calculating the most updated data at the source RDBMS tables. In step two, the loader program processes a pre-summary portion of the data and updates the target RDBMS tables with the newest data. One issue with the loader program is its execution performance. This is because in most cases the loader program must spend system resources and time to maintain the data at the target RDBMS. Therefore, if the results of the first step are not optimized, the second step's efficiency will be impacted resulting in poor overall performance for the loader program and slow data synchronization between source and target RDBMS's which might not be real time enough for the user's needs.

The current design of the CM loader program has one serious drawback. When the total number of records at the target the RDBMS becomes increasingly larger, such as when Work In Process (WIP) volume increases, the performance of step one will heavily slow down the overall performance of the CM loader program. This invention's method and system solve this performance problem. In U.S. Pat. No. 6,345,259 (Sandoval) a system and method for the integrating of business manufacturing environments is discussed. In U.S. Pat. No. 5,880,960 (Lin et al.) a method to improve WIP balance in a manufacturing line is discussed. In U.S. Pat. No. 5,612,886 (Weng) a method and system for dynamic dispatching is discussed. In U.S. Pat. No. 5,463,555 (Ward et al.) a system and method for integrating a business environment with a process control environment is discussed.

### SUMMARY OF THE INVENTION

This invention's overall objective is to provide a method of improving the performance of relational databases when doing data replication from a source database to a target database. It is a more specific objective to eliminate the need for the target database to be involved in calculating the new target's data. Another objective is to quickly perform an analysis by using the time and date stamp of the source database records to determine which data has changed. Yet other objectives are to perform the data reduction by deleting the changed records from the target data, and then inserting the updated changed records into the target database without any other further time-consuming checks necessary. Thus, the overall computer processing necessary to accomplish the data reduction is greatly reduced and performance is increased.

### BRIEF DESCRIPTION OF THE DRAWINGS

This invention will be described with reference to the accompanying drawings, wherein:

FIG. 1 is a flow diagram of the prior art method of keeping a real-time production database current.

FIG. 2 is a flow diagram of the new method of database updating.

FIG. 3 is an example block diagram showing initial state of a database table structure.

FIG. 4A, 4B, and 4C are example block diagrams showing the steps in changing the table structure of the new method.

### DETAILED DESCRIPTION OF THE PREFERRED EMBODIMENT

In today's manufacturing systems where numerous tools are needed to build a product, control of the system is essential. To achieve this, computer systems are used to monitor and run many of the tools as the speed, processing, and complexity are too much for individual operators to manage on a continual basis. This is especially true in the manufacture of semiconductor wafers and chips where product is processed in a strict sequence and any error can produce very expensive scrap. The ability to monitor this production in close to real time is essential for efficiency, quality, and cost effectiveness.

To monitor production in real time using a computer system, data must be gathered in real time by the system tools and processes. The most updated data at source RDBMS tables is calculated, and then a pre-summary portion is processed and displayed on a control monitor and the newest data is updated into target RDBMS tables. Execution performance can be an issue for the loader program as system resources and time must be spent to maintain data at the target RDBMS. Overall performance can be negatively impacted when the calculation of the most updated data at source RDBMS tables is not optimized. For example, with the current design of a CM loader program when the total count of records at the target RDBMS becomes larger (such as when WIP volume increases), the calculating of the most updated data requires more comparison time due to the increase in the number of records. This will slow down the overall performance of the CM loader program.

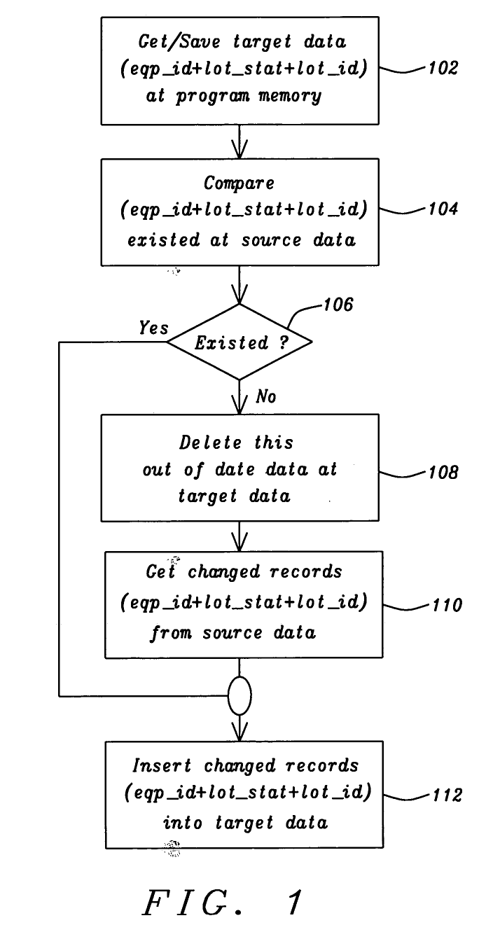

FIG. 1 shows the prior art method for keeping data current in a RDBMS. In the first block 102, all target data eqp_id +lot_stat+lot_id (a combination of equipment ID, lot status, and lot ID parameters) is gotten and stored in memory. Then the data is compared 104 with original source data. A check is done to find out which eqp_id +lot_stat+lot_id combinations existed in the source data 106. If no (such as a lot that was changed from one tool to another), this now out-of-date data is deleted from target data 108. If yes, the updated changed records are gotten from the source data 110 and inserted into the target data 112.

This process, although seemingly simple, in a real-time environment requires too much computer resource processing time and memory. As either the source or target table grows, both the procuring step 102 and comparing step 104 will take longer, perhaps so much longer that the data displayed is no longer in the immediate time frame that is necessary. Clearly, another method that has more efficient logic to maintain and synchronize data is necessary for better results. This invention optimizes the process and solves the problems.

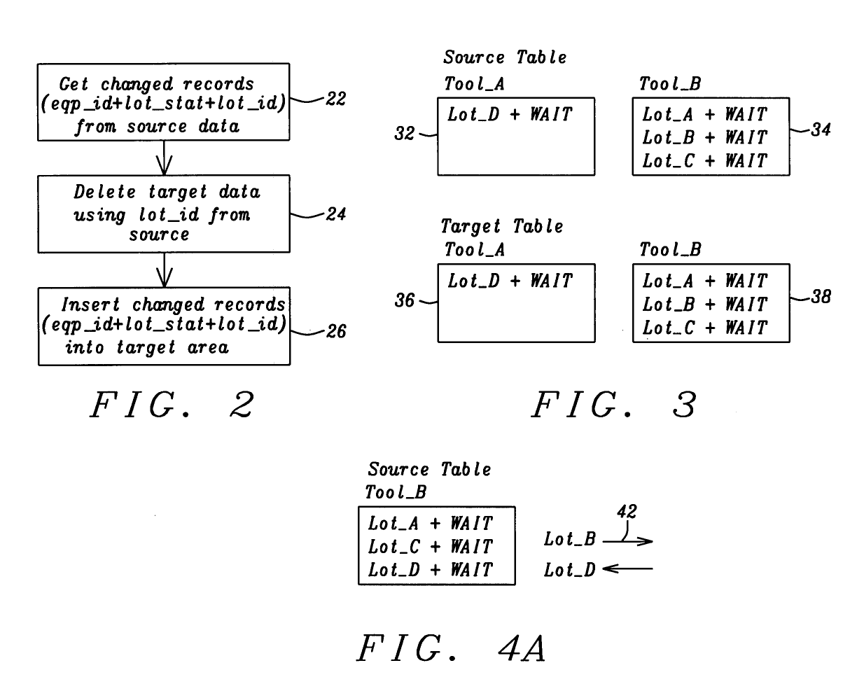

The new method of replication is simpler and requires much less computer resources, thus enabling more effective real-time operation. A loader program provides the computing power for the replication and is capable of displaying the manufacturing equipment environment and lot status on a central monitor. In FIG. 2, a block diagram of the new method flow is shown applied to an equipment WIP list where many lots can be associated with one piece of equipment. The equipment WIP list is started at the source RDBMS. The new method analyzes time and date stamp to determine if a record in the source database has been changed 22. A changed record results when the position of a lot is changed from one piece of equipment to another and includes the record that is no longer valid and its update. When the time and date stamp indicate a change, it locates the record according to its lot identifier in the source database and deletes the changed outdated record from the target data 24 thereby reducing the amount of data. The updated changed record is then inserted into the target data 26. This is called a Delete Changed First approach and eliminates the need for the target database to be involved in calculating new target data as only changed records in the source database are looked at. This conserves computer resources by being source data volume independent and eliminating the need to compare tables. This conservation of computer resources and the execution performance being independent of the volume of source data allows for real-time synchronization between the source equipment WIP list and the target equipment WIP list. Replicated data has the capability of being exported to another database or software system.

Now let us look at an example of how the records are actually changed. A source table that can be thought of as the master table contains the current WIP list of lots waiting for each piece of equipment or tool. It is maintained in real time by the Manufacturing Execution System (MES) which controls the entire manufacturing floor operation. To monitor the actual WIP lots, we need to periodically read the source table that is contained in an MES-controlled RDBMS. Since all the data contained in that database table is not needed for our display system, we create a simpler target data table to use for the GUI display program or central monitor.

Assume the current situation in source and target data tables is as in FIG. 3 for two tools called Tool A and Tool B. It shows the WIP lots that are waiting (WAIT) to be processed at each tool. The source table' content 32 34 is identical to the target table' content 36 38 at our starting instance. Tool A has Lot D waiting to be processed 32, and Tool B has lots A, B, and C waiting to be processed 34.

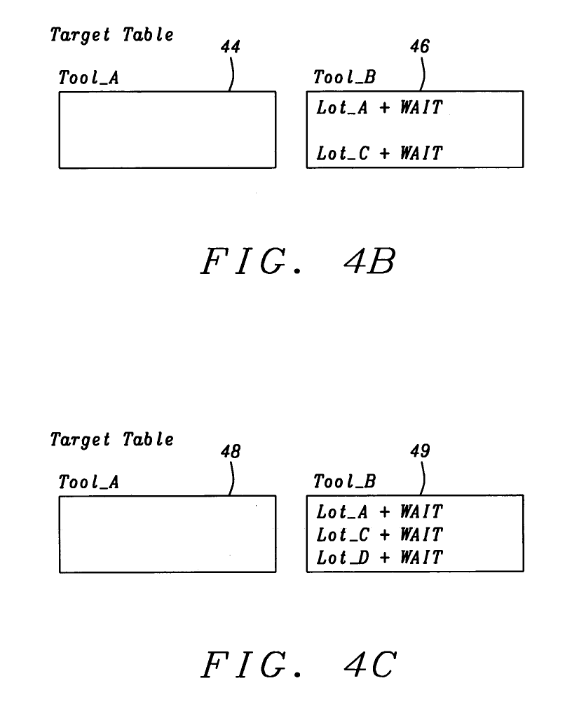

If an MES user performs a move operation on Tool B to move Lot B to another tool and adds a Lot D to Tool B 42 as shown in FIG. 4A, we now have two records in the source database table that are changed records. This is noted automatically in their records date and time stamp and leads us to an important observation. Since all lot movement will create a noted change in the date and time stamp of the record, it can simplify the method of updating the target database. If we look to Delete Changed First as our first step, the no-longer-valid records can be removed with no further checking or processing required, thus eliminating the time and resource consuming steps of the prior art method.

After deleting the changed records quickly from the target data table, the target data table looks like that of FIG. 4B. In this figure, Tool A 44 has had the Lot D removed and Tool B 46 has had Lot B removed. The updated changed records are now inserted into the target table. Lot D was moved from Tool A 48 to Tool B 49. Thus, FIG. 4C shows the now updated target table with Lot D now waiting in Tool B. The target table that Lot B was moved to would subsequently be updated. These updates are simple, fast, and allow the synchronization to take place in real time, thereby maintaining good performance. No other processing is required. The target becomes the source for the subsequent processing and the method is repeated again and again allowing for fast real-time display of the data with minimal computer resources used.

The method of the invention provides advantages over the prior art including making it possible to meet the real-time synchronization requirement at the loader program, speeding up generating performance and maintaining it even when source and target data grows, and using one source data changed record set to determine no longer valid records for deletion and insertion of updated records. The simpler, optimized steps of this invention eliminates the need for a comparison loop, thus conserving computer time and resources.

While the invention has been particularly shown and described with reference to preferred embodiments thereof, it will be understood by those skilled in the art that various changes in form and details may be made without departing from the spirit and scope of the invention.

1. A method of improving the performance of a relational database data reduction from a source database to target database, comprising of:
a. eliminating the need for said target database to be involved in calculating new target data;
b. analyzing time and date stamp to determine if record in said source database has been changed;
c. deleting changed records from the target data to perform said data reduction, and
d. inserting updates of said changed records into said target data.

2. The method of improving the performance of a relational database data reduction of claim 1, wherein an equipment work in process list where many lots can be associated with one piece of equipment is replicated between said source database and target database.

3. The method of improving the performance of a relational database data reduction of claim 2, wherein said changed records result from a changing of a lot position from one piece of said equipment to another.

4. The method of improving the performance of a relational database data reduction of claim 3, wherein only said changed records are looked at in said source database.

5. The method of improving the performance of a relational database data reduction of claim 4, wherein said changed records are records that are no longer valid and their updates.

6. The method of improving the performance of a relational database data reduction of claim 4, wherein only looking at said changed records conserves computer resources by being source data volume independent and eliminating need to compare tables.

7. The method of improving the performance of a relational database data reduction of claim 6, wherein the conservation of computer resources allows for real-time synchronization between source said equipment work in process list and target said equipment work in process list.

8. The method of improving the performance of a relational database data reduction of claim 1, wherein replicated data can be exported to another database or software system.

9. A method for refining data replication between a source database and a target database, comprising of:
a. locating changed records in said source database;
b. deleting the outdated said changed records from target data, and
c. inserting updated said changed records into target data.

10. The method for refining data replication between a source database and a target database of claim 9, wherein execution performance is independent of the volume of source data.

11. The method for refining data replication between a source database and a target database of claim 9, wherein said changed records are determined from analysis of time and date stamps in said source database.

12. The method for refining data replication between a source database and a target database of claim 9, wherein a loader program provides the computing power for the replication.

13. The method for refining data replication between a source database and a target database of claim 12, wherein said loader program is capable of displaying on a central monitor the manufacturing equipment environment and lot status.

14. A system for improving the performance of a relational database data reduction from a source database to target database, comprising of:
a. a means to eliminate the need for said target database to be involved in calculating new target data;
b. a means to analyze time and date stamp to determine if record in said source database has been changed;
c. a means to delete changed records from the target data to perform said data reduction, and
d. a means to insert updates of said changed records into said target data.

15. The system for improving the performance of a relational database data reduction of claim 14, wherein an equipment work in process list where many lots can be associated with one piece of equipment is replicated between said source database and said target database.

16. The system for improving the performance of a relational database data reduction of claim 15, wherein said changed records result from a changing of lot position from one piece of said equipment to another.

17. The system for improving the performance of a relational database data reduction of claim 16, wherein only said changed records are looked at in said source database.

18. The system for improving the performance of a relational database data reduction of claim 17, wherein said changed records are records that are no longer valid and their updates.

19. The system for improving the performance of a relational database data reduction of claim 17, wherein only looking at said changed records conserves computer resources by being source data volume independent and eliminating need to compare tables.

20. The system for improving the performance of a relational database data reduction of claim 19, wherein the conservation of computer resources allows for real-time synchronization between source said equipment work in process list and target said equipment work in process list.

21. The system for improving the performance of a relational database data reduction of claim 20, wherein replicated data can be exported to another database or software system.

22. A system for refining data replication between a source database and a target database, comprising of:
a. a means to locate changed records in said source database;
b. a means to delete the outdated said changed records from target data, and
c. a means to insert updated changed said records into said target data.

23. The system for refining data replication between a source database and a target database of claim 22, wherein execution performance is independent of the volume of source data.

24. The system for refining data replication between a source database and a target database of claim 22, wherein said changed records are determined from analysis of time and date stamps in said source database.

25. The system for refining data replication between a source database and a target database of claim 22, wherein a loader program provides the computing power for the replication.

26. The system for refining data replication between a source database and a target database of claim 25, wherein said loader program is capable of displaying on a central monitor the manufacturing equipment environment and lot status.
